(19) United States
(12) Patent Application Publication
(10) Pub. No.: US 2015/0016060 A1
(43) Pub. Date: Jan. 15, 2015

(54) Apparatus And Method For Cooling A Transformer Having A Non-Linear Core

(71) Applicant: ABB Technology AG, Zurich (CH)

(72) Inventors: Samuel S. Outten, Washington, DC (US); Thomas A. Hartmann, Forest, VA (US); Joel A. Kern, Wytheville, VA (US); Jarrett Terrell, Bland, VA (US); Chester M. Neal, Narrows, VA (US)

(21) Appl. No.: 14/366,481

(22) PCT Filed: Dec. 18, 2012
(86) PCT No.: PCT/US12/70227

§ 371 Date: Jun. 18, 2014

Related U.S. Application Data
(60) Provisional application No. 61/577,317, filed on Dec. 19, 2011.

(51) Int. Cl. H01F 27/20; H01F 27/24; H01F 27/28; H01F 41/02

(52) U.S. Cl. CPC H01F 27/20; H01F 41/02; H01F 27/24; H01F 27/2823
USPC 361/695; 29/428

(57) ABSTRACT

A three-phase non-linear transformer is cooled by first (30) and second fans (40). The first fan (30) is attached to the first core clamps (12) of the transformer using a first mounting structure (15). The second fan (40) is attached to the second core clamps (24) of the transformer using a second mounting structure (17). The first fan is positioned first so that air is directed toward a central passage of the core. The second fan is positioned so that air is drawn through the central passage of the core. The first fan circulates air through a central passage in the transformer core and channels that exist between adjacent coil assemblies. The second fan draws air through the central passage and channels and further expels the air into the surrounding environment. The first and second fans are controlled by a control panel through which they are run automatically or manually.

### FIELD OF INVENTION

The present application is directed to a forced air convection cooling method for a dry-type transformer having a non-linear core.

### BACKGROUND

During operation, dry-type transformers generate significant heat. Dry-type transformers are often designed with heat dissipation in mind, however, as power distribution demands increase, the need for efficient cooling is more pronounced. Continued exposure of the transformer core and coil windings to uncontrolled heat causes degradation of the insulating material over time and aging of the transformer. Uncontrolled heat in contact with the active parts of the transformer such as the core and coil assemblies has been known to reduce the service life of transformers.

Known methods of cooling dry-type transformers having linear or E-shaped cores include providing one or more fans located partially beneath each coil assembly and parallel to the lower yoke of the linear transformer. In many instances, two or more fans are provided for each coil assembly wherein fans are located at the front and back of each coil assembly along the core frame in a transformer having a linear core. When two fans are provided for each coil assembly, at least six fans are required for a three-phase transformer. Alternatively, cooling fans with a long axis have been used to dissipate heat in transformers having linear cores and have reduced the number of fans required in certain applications.

The cooling methods described above have also been applied to non-linear or delta core dry-type transformers, but primarily serve to cool the outer surfaces of the coil assemblies rather than uniformly or efficiently cooling the entire core and coil assemblies. Installation of the multiple fans used in prior art cooling configurations for non-linear transformers is labor intensive and costly. Therefore, there is a need for improved cooling methods for transformers having non-linear cores.

### SUMMARY

A three-phase non-linear transformer comprises a ferromagnetic core having at least three core legs arranged in a non-linear configuration, coil assemblies mounted to the at least three core legs, respectively, and a first fan aligned to provide airflow in a central passage. Each of the coil assemblies comprises a low voltage winding wound around each of the at least three core legs, respectively, and a high voltage winding disposed around the low voltage winding.

A method of cooling a non-linear transformer comprises positioning a first fan to direct air into a central passage located in the core of the non-linear transformer and mounting the first fan to the non-linear transformer so that the air is directed to the core central passage.

### BRIEF DESCRIPTION OF THE DRAWINGS

In the accompanying drawings, structural embodiments are illustrated that, together with the detailed description provided below, describe exemplary embodiments of a method for cooling a transformer having a non-linear core. One of ordinary skill in the art will appreciate that a component may be designed as multiple components or that multiple components may be designed as a single component.

Further, in the accompanying drawings and description that follow, like parts are indicated throughout the drawings and written description with the same reference numerals, respectively. The figures are not drawn to scale and the proportions of certain parts have been exaggerated for convenience of illustration.

FIG. 1 shows a front view of a non-linear transformer having a first fan attached to first core clamps and a second fan attached to second core clamps through first and second mounting structures.

FIG. 2 is a top plan view of the non-linear transformer having a central passage and channels that permit air flow across coil assemblies of the transformer.

FIG. 3 is an exploded view of the non-linear transformer of FIG. 1 having first and second fans and arrows to show the air flow along the coil assemblies of the transformer.

FIG. 4 depicts a temperature monitor for controlling the first, second, and any additional fans utilized.

### DETAILED DESCRIPTION

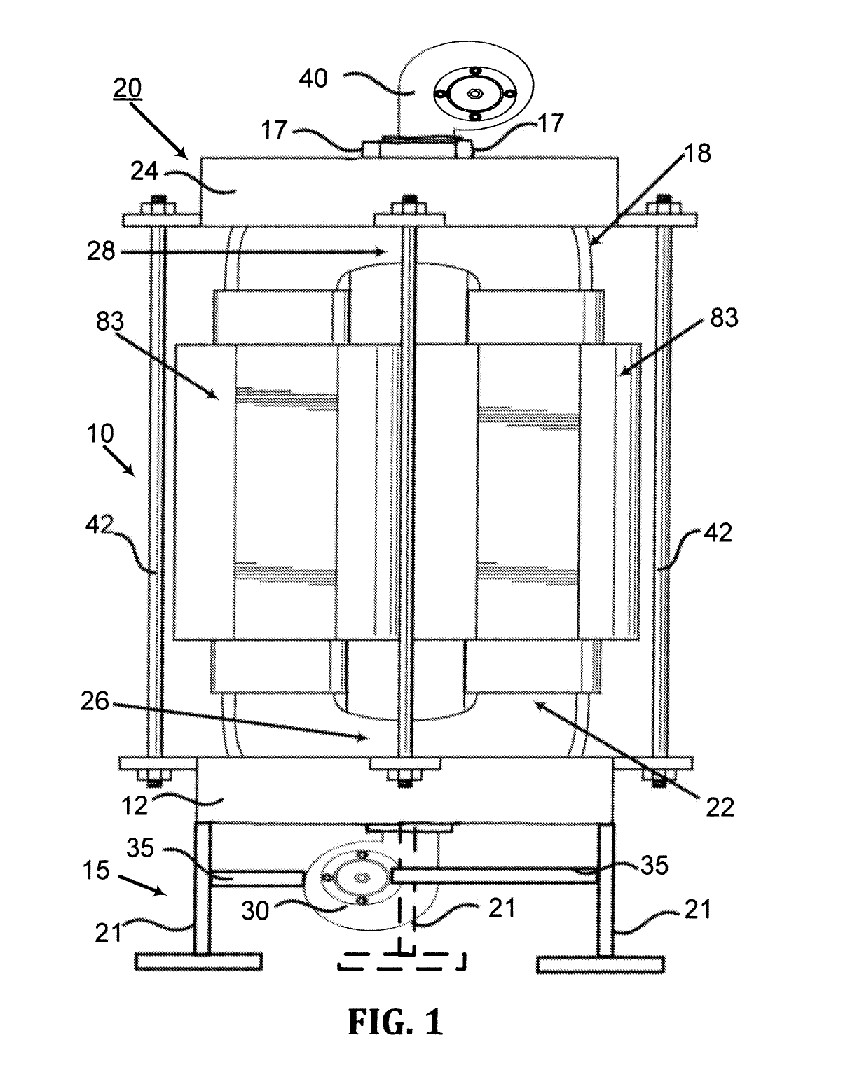

A three-phase non-linear dry-type transformer 10 (hereinafter “transformer 10”) is shown in FIG. 1. The exemplary transformer 10 is comprised of three core frames 22 that are arranged in a triangular or “delta” configuration. As depicted in FIG. 1, one of the three core frames 22 faces forward whereas the other two core frames 22 are hidden from view and face rearward.

The transformer 10 has exemplary first core clamps 12 and second core clamps 24 that secure the transformer core 18. A transformer cooling assembly 20 is formed by a first fan 30 and a second fan 40 attached to the first and second core clamps 24 through first and second mounting structures 15, 17, respectively. The transformer cooling assembly 20 provides a forced air convective cooling path to reduce the operating temperature of the core 18 and coil assemblies 83.

The first and second core clamps 12, 24 are each comprised of three channel members formed from steel or aluminum and are connected in a triangular configuration. The first and second core clamps 12, 24 are connected together axially by connecting rods 42 or leg plates. It should be appreciated that the first and second core clamps 12, 24 may be formed from members that are of a different shape, material, or are connected in another configuration, depending on the application.

The first mounting structure 15 is embodied as a square or triangular platform comprising c-channel members having legs 21 extending downward from vertices of the first core clamps 12. One of the legs 21 is shown in phantom to indicate that the leg 21 is positioned behind the first fan 30 and extends from the vertex of the first mounting structure 15 that is positioned rearward.

The first mounting structure 15 provides the clearance required for the first fan 30. The transformer 10 must be raised from the floor or other mounting surface to allow clearance for the first fan 30. The legs 21 connect and extend from the vertices of the first core clamps 12 in the case of a triangular first mounting structure 15. The first fan 30 is mounted to at least two braces 35 that connect to the legs 21, respectively. The output of the first fan 30 is directed at about the level of the bottom of the yoke section 26 to about twelve inches from the periphery of the lower yoke section 26 of the core 18.

The second mounting structure 17 is positioned above the second core clamps 24. The second mounting structure 17 is comprised of two c-channel members upon which the second fan 40 is mounted. The output of the second fan 40 is from about the level of the top of the yoke section 28 to about 12 inches from the periphery of the upper yoke section 28 of the core 18. Alternatively, the second mounting structure 17 may have tabs (not shown) that extend downward from a triangular or square platform formed by at least two braces 35 in the same manner as the first mounting structure 15. The tabs are utilized to attach the platform of the second mounting structure 17 to the second core clamps 24.

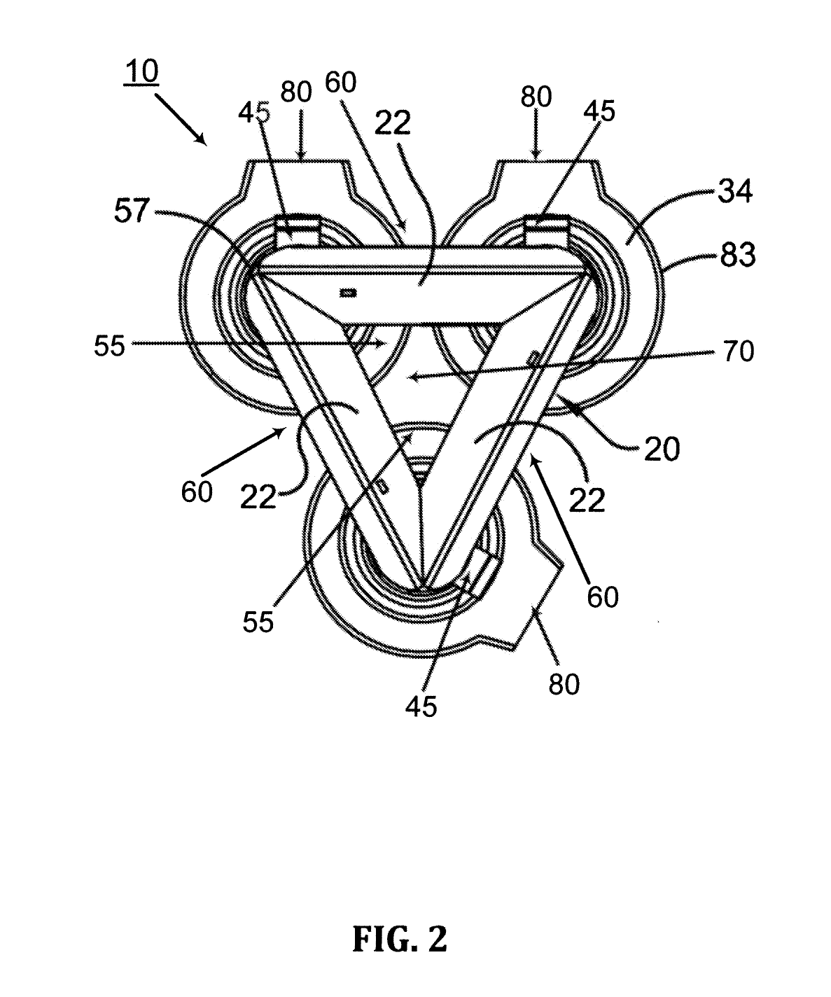

The first fan 30 is positioned to direct air through a central passage 70 in the transformer core 18, along the coil assemblies 83 and through channels 60 between adjacent coil assemblies 83 as depicted in FIG. 2. The passage 70 is generally polygonal in shape and formed by the confluence of inner portions 55 of the coil assemblies 83. The inner portions 55 of the coil assemblies 83, respectively, experience cooling due to the alignment of the first and second fans 30, 40 with the central passage 70 of the core 18. The channels 60 extend axially between the coil assemblies 83 and permit air circulation between the coil assemblies 83. FIG. 2 depicts the coil assemblies 83 as each having a dome 80 for housing at least one tap, however, the coil assemblies may be embodied without domes 80.

Additionally, the first fan 30 directs air through cooling ducts (not shown) formed in the coil assemblies 83, typically in a cast secondary coil winding. The second fan 40 draws the air upward through the central passage 70, channels 60, and ducts of the transformer 10. The air is drawn into the second fan 40 through ventilation openings 66 in the second fan 40 and expelled into the surrounding environment. It should be understood that the first fan 30 also has ventilation openings 66 for directing air outward.

The first and second fans 30, 40 are embodied as centrifugal fans, axial fans or another other type of fan or combination of fans suitable for the application. An example of a fan that is suitable for cooling the transformer 10 is model no. SP-B9MV1, rating 0.53A @1550 RPM from Morrill Motors Inc. of Fort Wayne, Ind.

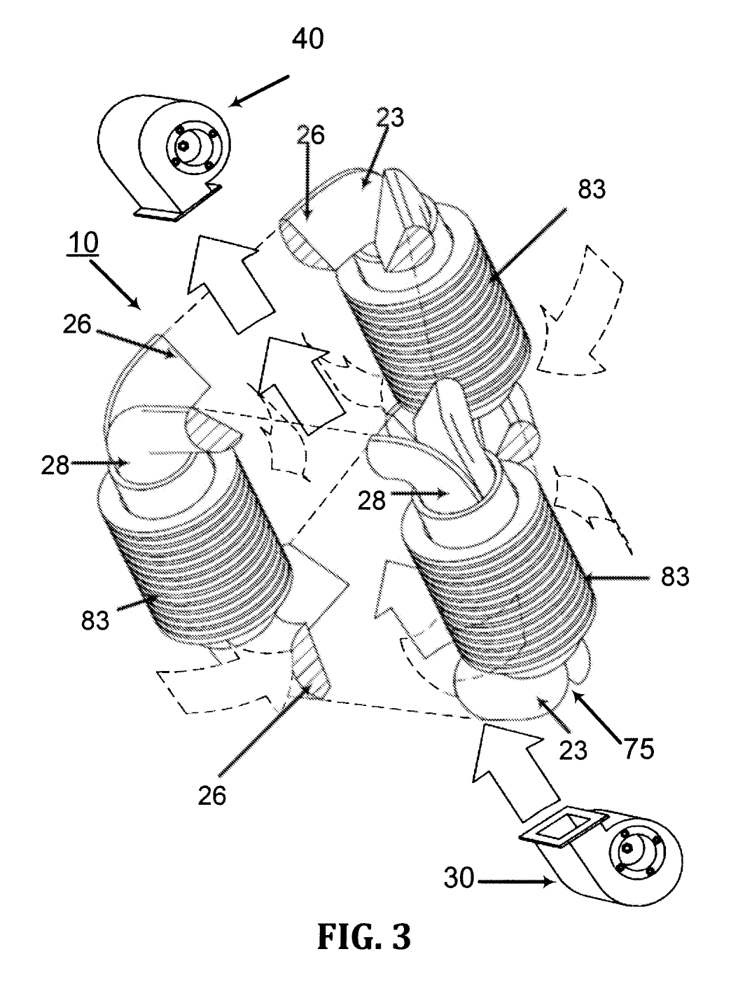

With reference now to FIG. 3, an exploded view of the transformer 10 is shown with arrows to indicate the circulation path of the forced air across the core 18 and coil assemblies 83 of the transformer 10. For explanatory purposes, at least three core frames 22 comprise the ferromagnetic core 18 of the non-linear transformer 10. Each of the at least three core frames 22 are wound from one or more strips of metal such as grain-oriented silicon steel and/or amorphous metal. Each of the at least three core frames 22 has a generally rounded rectangular shape and is comprised of opposing yoke sections 26 and opposing leg sections 28. The leg sections 28 are substantially longer than the yoke sections 26. The leg sections 28 are joined to the yoke sections 26 by shoulders 23.

The non-linear transformer 10 is assembled by aligning the leg sections 28 of each of the at least three core frames 22 to abut adjacent leg sections 28 of the other core frames 22 so that a triangular shape is apparent when viewing the transformer from above, as best depicted in FIG. 2. Each set of two abutting leg sections 28 forms a core leg 38. The assembled core 18 is held together using a plurality of bands that are securely disposed around the abutting leg sections 28 to secure the core frames 22 in a triangular or delta configuration. The bands are composed of an insulating material such as plastic or an adhesive glass tape.

Coil assemblies 83 are mounted to the core legs 38, respectively. Each coil assembly 83 comprises a high voltage winding 34 and a low voltage winding 57. The low voltage winding 57 is typically disposed within and radially inward from the high voltage winding 34. The high and low voltage windings 34, 57 are formed of a conductive material such as copper or aluminum. The high and low voltage windings 34, 57 are formed from a sheet of conductor, a wire of conductor having a generally rectangular or circular shape, or a strip of conductor.

When the first and second fans 30, 40 are utilized, the circulation path of the forced air from the first fan 30 is directed upward through the central passage 70 and the second fan 40 draws the air further through the passage 70, causing the air to exit through the top of the passage 70 and/or channels 60. In that same embodiment, the blades of the second fan 40 rotate in the opposite direction of the blades of the first fan 30, applying a suction force to draw in the forced air. As shown in FIG. 3, the air generated by the first fan 30 is circulated under the corners 75 of the core 18 where the core leg sections 28 meet, around the yoke sections 26, around the coil assemblies 83, through the channels 60 and central passage 70. The second fan 40 then draws the air through the central passage 70 and expels the air into the environment.

Alternatively, only one of the first and second fans 30, 40 may be utilized. In an embodiment wherein only the first fan 30 is utilized, the first fan is mounted underneath the transformer 10. The output of the first fan 30 directs air upward through the central passage 70, channels 60, along the coil assemblies and through the ducts (if present).

In an embodiment wherein a single second fan 40 is mounted above the transformer 10, the second fan 40 has an output directing air upward above the transformer, as the input air is drawn from the central passage 70, channels 60, along the coil assemblies 83 and through the cooling assembly ducts (if present).

In another embodiment, one or both of the first and second fans 30, 40 are utilized in conjunction with additional fans that are mounted parallel to the core yoke sections 26 and/or mounted at the vertices of the first and second core clamps 12, 24. Mounting additional fans to the vertices of the first and second core clamps serves to cool the corner 75 where the core frames 22 meet as well as the sides of the coil assemblies 83. Alternatively, the additional fans may be mounted so that two fans surround each of the vertices of the first and second core clamps 12, 24.

It should be appreciated that the output of a single fan may be mounted or directed to the top or bottom of the core 18. In one embodiment, the first fan 30 is attached so that the output of the fan is directed up at the bottom of the core and thus through the central passage 70.

In another embodiment having a single fan, the second fan 40 is mounted so that the output is directed down through the top of the core 18 and thus through the central passage 70. In that same embodiment, an external circulation mechanism is used to dissipate heat from the core 18 that is generated during the operation of the transformer 10.

The first and second fans 30, 40 and any additional fans utilized in the transformer cooling assembly 20 are electrically connected to and powered by one, two or three phases of the transformer 10. The first 30, second 40, and any additional fans are electrically connected to low voltage leads 45 that extend from the secondary windings 57 of the transformer 10.

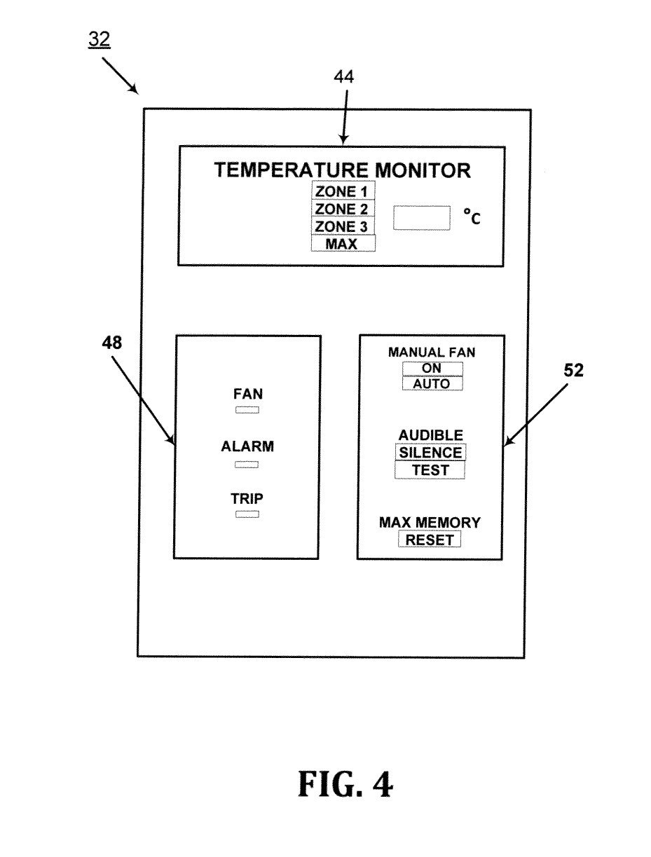

Referring now to FIG. 4, the first and second fans 30, 40 and any additional fans are controlled by a control panel 32 having three functional areas 44, 48, 52. The control panel 32 is in thermal communication and connection with the coil assemblies 83. The control panel 32 may be embodied as a human-machine interface (HMI) or another user interface.

The first functional area 44 of the control panel 32 allows the user to set a predetermined temperature threshold. Upon one of the coil assemblies 83 (or phases) reaching the temperature threshold, the first and second fans 30, 40 and any additional fans are activated. Settings for Zone 1, Zone 2, and Zone 3 may be used to set the threshold temperature for each phase, respectively. Additionally, settings for Zone 1, Zone 2 and Zone 3 may be used to control additional fans that are mounted at each vertex of the first and second core clamps 12, 24. The Max setting is used to input the maximum temperature threshold for a coil assembly 83 or a position along a coil assembly 83.

The second functional area 48 of the control panel 32 comprises indicator lights. The illumination of the fan indicator light means that one or more fans are active. The illumination of the alarm light means that an audible alarm condition has been sounded upon the detection of a temperature at or above the predetermined temperature threshold. The illumination of the trip light means that power is disconnected at the transformer. Power may be disconnected at the transformer 10 on command or upon detection of a fault condition by an electrical disconnect device such as a circuit breaker or other device suitable for the application. Fault conditions may include a temperature rise above the predetermined temperature threshold or another event.

The third functional area 52 of the control panel 32 comprises settings for activating the fans manually or automatically. The fans may be automatically activated upon reaching a predetermined temperature threshold set in the first functional area 44 of the control panel 32. Alternatively, the fans may be run manually and will run continuously until powered down. The third functional area 52 also allows the user to silence the alarm or to test the alarm settings.

The control panel 32 monitors the temperature of the coil assemblies 83 through connection with a thermocouple. The thermocouple is installed in an air duct of the low voltage, or secondary winding of each of the coil assemblies 83, respectively. The thermocouple is secured over a tube that is embedded in the air duct. The tube is formed of polytetrafluoroethylene, such as is sold under the trademark TEFLON®, or another material suitable for the application.

It should be understood that the first 30, second 40 and any additional fans may be activated based on other threshold temperatures, parameters, sensors, or sensor locations depending on the application.

The transformer cooling assembly 20 utilizing first and second fans 30, 40 has been experimentally shown by the inventors to decrease the temperature experienced at the phases of the transformer by 20 degrees Kelvin. The path of the forced air created by the first and second fans 30, 40 contacts a large surface area of the core 18 and coil assemblies 83, allowing the transformer 10 to be cooled efficiently, by preventing or impeding the development of hot spots and eddy currents. The efficiency of the transformer cooling assembly 20 as demonstrated in experimental testing, allows the transformer 10 to operate at a higher rating, such as increasing the continuous self-cooled rating of the non-linear transformer by about 25%.

It should be appreciated that instead of mounting the first and second fans 30, 40 to first and second mounting structures 15, 17, the first and second fans 30, 40 may be mounted to an enclosure surrounding the transformer 10. The enclosure has one or more side walls, a bottom wall and a top wall. In a transformer 10 installation where an enclosure is utilized, the second fan 40 is mounted to the inside of the top wall of the enclosure. In that same embodiment, the transformer 10 is suspended above the bottom wall of the enclosure using hooks that extend from the ceiling of the enclosure. The hooks engage with eyebolts or other mounting structures suitable for the application that are attached to the second core clamps 24 of the transformer 10. The suspension of the transformer 10 above the floor of the enclosure allows enough clearance for the first fan 30 to be attached to the bottom wall of the enclosure or a first mounting structure 15 further attached to the bottom wall of the enclosure.

Alternatively, the transformer 10 may installed to the bottom wall of an enclosure or a room using feet. The clearance required for installation of the first fan 30 is achieved using feet that have a predetermined height. The feet have a rectangular or a butterfly shape. The feet are attached to the first core clamps 12 and further attached to the bottom wall of the enclosure or room.

In one embodiment, the forced air generated by the first fan 30 is drawn by the second fan 40 into a plenum mounted to the top of the enclosure. The plenum is a horizontally extending duct attached to the top of the transformer enclosure. In an embodiment having an enclosure and a plenum, the first and second fans 30, 40 direct thermally excited air into the plenum where it is removed from the pattern of re-circulated air of the overall forced air convective cooling system.

The first and second fans 30, 40 are used in combination, singly, or with one or more additional axial or centrifugal fans. The first and second fans 30, 40 are used to cool the active components such as the core 18 and coil assemblies 83 of a transformer having coil assemblies 83 that are open wound, cast, vacuum pressure impregnated, vacuum pressure encapsulated, or formed using another method.

It should be appreciated that the transformer cooling assembly 20 may be utilized with a transformer core 18 that has a hexahedral shape or another polygonal shape other than triangular.

The first and second fans 30, 40 may be retrofit for installation on existing non-linear transformers. The transformer 10 core clamps may need to be adapted for mounting the first and second fans 30, 40 and the transformer 10 should be raised from any resting surface to allow clearance for installation of the first fan 30.

While the present application illustrates various embodiments, and while these embodiments have been described in some detail, it is not the intention of the applicant to restrict or in any way limit the scope of the appended claims to such detail. Additional advantages and modifications will readily appear to those skilled in the art. Therefore, the invention, in its broader aspects, is not limited to the specific details, the representative embodiments, and illustrative examples shown and described. Accordingly, departures may be made from such details without departing from the spirit or scope of the applicant's general inventive concept.

What is claimed is:

1. A three-phase non-linear transformer, comprising:
a ferromagnetic core having at least three core legs arranged in a non-linear configuration;
coil assemblies mounted to the at least three core legs, respectively, each of the coil assemblies comprising:
a low voltage winding wound around each of the at least three core legs, respectively; and
a high voltage winding disposed around the low voltage winding; and
a first fan aligned to provide airflow in a central passage in the transformer core, said first fan directing air flow through said central passage.

2. The non-linear transformer of claim 1 wherein the at least three core legs are arranged in a triangular configuration.

3. The non-linear transformer of claim 2 wherein said first fan is mounted to lower core clamps of the non-linear transformer using a first mounting structure.

4. The non-linear transformer of claim 3 wherein said first mounting structure is comprised of a generally triangular-shaped platform having at least two braces, said platform connected at a midpoint of legs extending downward from vertices of said first core clamps, said first fan mounted at the intersection of said at least two braces.

5. The non-linear transformer of claim 2 wherein a second fan is aligned to circulate air through said central passage, drawing air into said second fan from said central passage.

6. The non-linear transformer of claim 5 wherein an output of said second fan is attached to second core clamps using a second mounting structure.

7. The non-linear transformer of claim 6 wherein said second mounting structure is comprised of c-channel members connected to said second core clamps, said second mounting structure members positioned over opposing sides of the central passage, said second fan output mounted to said second mounting structure members.

8. The non-linear transformer of claim 6 wherein said second mounting structure is comprised of a generally triangular-shaped platform formed of at least two braces, said platform connected to said second core clamps through tabs located at the vertices of said platform, said second fan mounted at the intersection of said braces.

9. The non-linear transformer of claim 5 wherein said first and second fan operation is controlled by a control panel in thermal connection with said coil assemblies, said human-machine interface having a predetermined temperature threshold.

10. The non-linear transformer of claim 5 wherein when a sensor in communication with said control panel thermally senses a temperature above said predetermined temperature threshold, said first and second fans are activated.

11. The non-linear transformer of claim 5 wherein said first and second fans are activated manually.

12. A method of cooling a non-linear transformer, comprising:
a. Positioning a first fan to direct air into a central passage located in the core of said non-linear transformer; and
b. Mounting said first fan to said non-linear transformer so that said air is directed to said core central passage.

13. The method of claim 12, further comprising:
c. Positioning a second fan to draw air through said core central passage;
d. Mounting said second fan to said non-linear transformer so that air is drawn through said core central passage.

14. The method of claim 13 wherein said first fan is mounted to a bottom wall of an enclosure.

15. The method of claim 14 further wherein said second fan is mounted to a top wall of said enclosure.

16. The method of claim 13 wherein said first fan is mounted to lower core clamps of said non-linear transformer.

17. The method of claim 16 wherein said second fan is mounted to upper core clamps of said non-linear transformer.

18. The method of claim 13, further comprising:
e. Setting a temperature threshold for the coil assemblies in a control panel in thermal communication with said first and second fans;
f. Activating said first and second fans upon reaching the threshold temperature.

19. The method of claim 13, further comprising:
e. Activating said first and second fans manually using a control panel in thermal connection with said first and second fans.

20. The non-linear transformer of claim 1 wherein the at least three core legs are arranged in a hexahedral configuration.
